(19) United States
(12) Patent Application Publication
(10) Pub. No.: US 2004/0219980 A1
(43) Pub. Date: Nov. 4, 2004

(54) Method and apparatus for dynamically controlling camera parameters based on game play events

(75) Inventors: Scott Bassett, Bellevue, WA (US); Shigeki Yamashiro, Redmond, WA (US)

Correspondence Address: NIXON & VANDERHYE, P.C., 1100 N. GLEBE ROAD, 8TH FLOOR, ARLINGTON, VA, 22201, US

(73) Assignee: Nintendo Co., Ltd., Kamitoba Minami-ku (JP)

(21) Appl. No.: 10/636,980

(22) Filed: Aug. 8, 2003

Related U.S. Application Data
(60) Provisional application No. 60/466,423, filed on Apr. 30, 2003.

(51) Int. Cl. A63F 13/00

(52) U.S. Cl. 463/33; 463/32; 463/6

(57) ABSTRACT

Dynamic virtual camera effects for video game play and other computer graphics simulations enhance the illusion of speed and provide interesting split-screen displays. One aspect narrows the field of view of a virtual camera while simultaneously increasing the distance between the virtual camera and a moving object as the speed of the moving object through the three-dimensional scene increases. This provides the illusion of speed while avoiding distortions caused by changing the apparent size of the displayed object. Another aspect selectively activates a split-screen display showing a moving object from a different viewpoint when the moving object moves into proximity.

### CROSS-REFERENCES TO RELATED APPLICATIONS

Priority is claimed from application Ser. No. 60/466,423 filed Apr. 30, 2003, which is incorporated herein by reference.

### FIELD

The subject matter herein generally relates to three-dimensional video game play and other video simulations, and more particular to dynamically manipulating camera angle to provide special effects such as sensation of speed and split-screen effects.

### BACKGROUND AND SUMMARY

Three-dimensional video game platforms bring realistic and exciting game play to living rooms across the world. In a 3-D video game, one manipulates and moves characters through an often-complex three-dimensional world. Characters can be moved uphill and downhill, through tunnels and passageways of a castle, between trees of a forest, over interesting surfaces such as deserts or ocean surf—some characters can even fly into the air.

Video game developers continually want to make game play more interesting by adding special and other effects. The modern generation of teenage video game players has been exposed to a variety of fast-paced television programs and movies. Sports television broadcasts now include enhancements such as instant replays from various camera angles and digitally added imaging (e.g., the line of scrimmage in a football game). Movies often include dazzling special effects that draw the viewer into the movie and make it feel as if he or she is part of the action. Given that much of the modern video game player's experience comes from mass media sources, it may not be enough for a video game to merely simulate real life. If the video game player has never been to an actual football game but rather has spent many hours watching football on television, it may be desirable for a football video game to be successful to simulate the television broadcasting approach to watching football as much as simulating what one would experience watching football in a stadium.

One known way to add interest and excitement to video game play is to manipulate the viewpoint. While many video games include live video action clips, most video game play continues to be of the animated type where no real cameras are used. However, one common way to design a video game is for the video game designer to create and model one or more virtual cameras using computer software. The video game designer can define a virtual camera as an object anywhere within the three-dimensional world. The camera object can be moved dynamically as game play proceeds. For example, the camera might follow a character from a distance as the character moves through the scene. The game player may be able to control or influence camera position by manipulating handheld controls. Often it is also possible to zoom in or out-changing the virtual camera's field of view or position in the same way as one adjusts the field of view of a telephoto lens on a real camera. Some video games even include different cameras that the video game player can switch between by depressing buttons on a handheld controller. For example, a common technique for an aircraft flight simulator or flying game is to allow the video game player to select between a camera within the aircraft's cockpit and another camera positioned outside of the aircraft that shows the aircraft flying through the air and interacting with other objects in the three-dimensional world.

Video game designers sometimes think of video game play as a movie set. The designer creates a three-dimensional landscape (e.g., a ski slope, a race track, a football stadium, a castle, a forest or desert, or any other realistic or fantastic landscape) through which objects can move and interact with other objects. Just like in movie or television filming, it is also possible to vary a video game “camera” position and field of view to increase interest and interactivity.

Think of how a well-cinemagraphed movie uses different camera positions and angles for effect. When a character is talking, the camera usually zooms in on that character for a close-up. When another character begins speaking, the camera zooms in on that character. For group action, a wider camera field of view is used to sweep in all of the characters. Some films occasionally even use first-person camera positions so the viewer can see what the character would see moving through the landscape. Think for example of watching a car, a bobsled race or a skiing competition when the broadcast switches to a camera mounted in the car or on a participant's helmet. A distinguishing characteristic of real life driving/racing is the sense of speed obtained by going fast. It would be desirable to portray this sense of speed while also giving an optimal view of the race ahead. These interesting effects could add substantially to the excitement and realism of the game play experience.

One interesting technique in video games to create the illusion of speed is to change the viewing angle of the video game's virtual camera according to the rate an object is moving. In the real world, you have the sensation of moving very rapidly when objects in your peripheral vision are blurred and move by you very quickly. This same effect can be used in video game play by narrowing the field of view of a virtual camera trained on the moving character or other object—causing peripheral objects to move very quickly in and out of the camera's field of view. This can create a sensation of speed.

Also in the past, some video games have been designed to make use of split screen displays. For example, one prior technique uses different virtual cameras for different objects, and provides a split display with one camera viewpoint focused on one object and another camera viewpoint focused on another object. Some video games have multiple split screens with, for example, one screen showing a cockpit or dashboard view, another screen showing a view of the racetrack as might be seen from a helicopter flying overhead or from the grandstands. A third split screen sometimes shows a map of the racetrack with the position of each car or other object.

While much work has been done in the past, further improvements are possible and desirable.

In accordance with one exemplary non-limiting embodiment, both the field of view of a virtual camera and the distance of the virtual camera from an object are controlled in response to the rate of motion of the object through a three-dimensional scene. More particularly, in one example illustrative non-limiting embodiment, as the rate of motion of an object through a three-dimensional world increases, the field of view of the virtual camera trained on that object is narrowed to create an illusion of speed. However, to avoid distorting the apparent size of the moving object on the screen, as the field of view is changed, the distance of the viewpoint from the moving object is also changed correspondingly.

In one exemplary non-limiting embodiment, the distance parameter is changed simultaneously with the camera's field of view to maintain a constant apparent object size. For example, as the virtual camera “zooms in”, the distance from the virtual camera to the moving object is simultaneously increased so the size of the object displayed on the screen remains essentially constant. By setting both the viewing angle and the distance between the moving object and the viewing point based on the rate of motion of the moving object, it becomes possible to create interesting effects such as a sensation of speed without changing the apparent size of the object displayed on the screen.

Exemplary non-limiting steps include calculating a time based on the object's speed and a function allowing for camera ease-in and ease-out; and interpolating camera parameters from starting and ending parameters.

In accordance with a further exemplary non-limiting embodiment, as the rate of speed of the manipulated object increases, the viewing angle is reduced and the distance between the manipulated object and the viewing point is increased. Therefore, without changing the size of the manipulated object, it is possible to show a sensation of high speed when it becomes difficult to see objects in peripheral vision because they are moving quickly relative to the player's virtual point of view. For example, suppose a moving object within a video game is descending a hill. As the speed of the moving object increases, it is possible to increase the height of the viewing point so that the hill appears to be steeper and the sensation of speed is increased. This effect can add a high degree of interest and additional realism in many video games and other simulations where it is desirable to create an illusion of speed.

In accordance with a further non-limiting exemplary illustrative embodiment, different camera angles are selected when a moving object moves into proximity to an arbitrary point. For example, when a moving object moves close to an arbitrary or predetermined position within the three-dimensional world, a second virtual camera can be activated and the second image is split-view superimposed on the original image. The original image may be seen from the viewing point of an initial virtual camera, and the second, split-screen superimposed image may be viewed from a second viewing point pointed in a different direction and/or angle. This allows the video game player to see the object from different angles.

In one exemplary non-limiting embodiment, the split screen is activated only at certain times, e.g., when the moving object within the video game is in proximity to a certain position. That position or location may be predetermined. The split-screen effect can thus provide additional interesting information without becoming a distraction. For example, in a racing game, if a car is about to crash into a wall, it becomes possible to display a split-screen effect with the original camera angle continuing to show a dashboard, a trailing view or other view, and the split-screen showing the point of impact. As another example, when the moving object approaches a hill having a steep grade, the split-screen can be used to show the hill from a different angle so the video game player can recognize how steep the hill is. This effect can also be used for example to allow the video game player to view an especially difficult but successful maneuver from a variety of different viewing angles.

In accordance with an exemplary illustrative implementation, when the moving object moves out of proximity with the predetermined or arbitrary point, the split-screen image is removed. In this way, the video game player can easily recognize that he or she has passed the split-display point. The viewing point of the second virtual camera can be set to any viewing point within a three-dimensional space (i.e., x, y, z can each range anywhere within 360°). The viewing point can therefore be freely set according to conditions existing at that viewing point.

### BRIEF DESCRIPTION OF THE DRAWINGS

These and other features and advantages will be better and more completely understood by referring to the following detailed description in conjunction with the drawings. The file of this patent contains at least one drawing executed in color. Copies of this patent with color drawing(s) will be provided by the Patent and Trademark Office upon request and payment of the necessary fee.

FIGS. 1 and 2 show an exemplary video game playing system;

FIG. 3 shows an exemplary three-dimensional virtual universe including a virtual camera model;

FIG. 4 shows an exemplary virtual camera view using a narrower field of view;

FIG. 5 shows an exemplary virtual camera view showing a wider field of view;

FIG. 6 shows a top view of an exemplary change in virtual camera field of view and distance based on moving object rate of motion;

FIG. 7 shows a side view of the exemplary arrangement shown in FIG. 6;

FIGS. 8A and 8B show exemplary flowcharts of stored program instruction controlled operations;

FIGS. 9A and 9B show example screen shots;

FIG. 10 shows an exemplary side view using a second camera display activated when the moving object is in proximity to a predetermined position;

FIG. 11 shows an exemplary flowchart of stored program instruction controlled operations; and

FIG. 12 shows an exemplary on-screen display.

### DETAILED DESCRIPTION

Example Illustrative Non-Limiting Video Game Platform

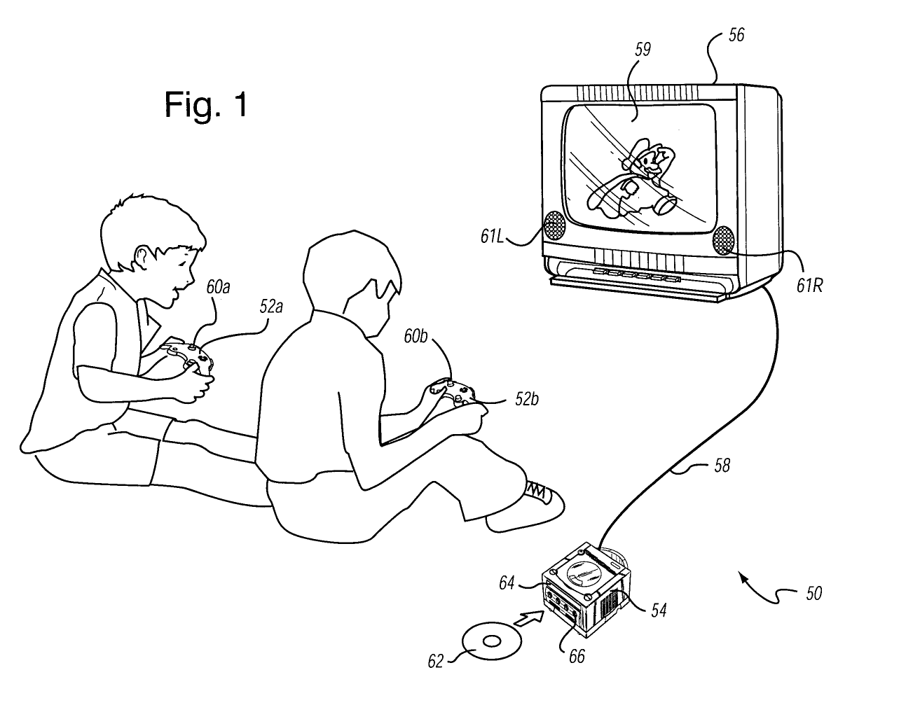

FIG. 1 shows an example interactive 3D computer graphics system 50. System 50 can be used to play interactive 3D video games with interesting stereo sound. It can also be used for a variety of other applications.

In this example, system 50 is capable of processing, interactively in real time, a digital representation or model of a three-dimensional world. System 50 can display some or all of the world from any arbitrary viewpoint. For example, system 50 can interactively change the viewpoint in response to real time inputs from handheld controllers 52a, 52b or other input devices. This allows the game player to see the world through the eyes of someone within or outside of the world. System 50 can be used for applications that do not require real time 3D interactive display (e.g., 2D display generation and/or non-interactive display), but the capability of displaying quality 3D images very quickly can be used to create very realistic and exciting game play or other graphical interactions.

To play a video game or other application using system 50, the user first connects a main unit 54 to his or her color television set 56 or other display device by connecting a cable 58 between the two. Main unit 54 in this example produces both video signals and audio signals for controlling color television set 56. The video signals are what controls the images displayed on the television screen 59, and the audio signals are played back as sound through television stereo loudspeakers 61L, 61R.

The user also connects main unit 54 to a power source. This power source may be a conventional AC adapter (not shown) that plugs into a standard home electrical wall socket and converts the house current into a lower DC voltage signal suitable for powering the main unit 54. Batteries could be used in other implementations.

The user may use hand controllers 52a, 52b to control main unit 54. Controls 60 can be used, for example, to specify the direction (up or down, left or right, closer or further away) that a character displayed on television 56 should move within a 3D world. Controls 60 also provide input for other applications (e.g., menu selection, pointer/cursor control, etc.). Controllers 52 can take a variety of forms. In this example, controllers 52 shown each include controls 60 such as joysticks, push buttons and/or directional switches. Controllers 52 may be connected to main unit 54 by cables or wirelessly via electromagnetic (e.g., radio or infrared) waves.

To play an application such as a game, the user selects an appropriate storage medium 62 storing the video game or other application he or she wants to play, and inserts that storage medium into a slot 64 in main unit 54. Storage medium 62 may, for example, be a specially encoded and/or encrypted optical and/or magnetic disk. The user may operate a power switch 66 to turn on main unit 54 and cause the main unit to begin running the video game or other application based on the software stored in the storage medium 62. The user may operate controllers 52 to provide inputs to main unit 54. For example, operating a control 60 may cause the game or other application to start. Moving other controls 60 can cause animated characters to move in different directions or change the user's point of view in a 3D world. Depending upon the particular software stored within the storage medium 62, the various controls 60 on the controller 52 can perform different functions at different times.

Example Non-Limiting Electronics and Architecture of Overall System

FIG. 2 shows a block diagram of example components of system 50. The primary components include:

a main processor (CPU) 110,

a main memory 112, and

a graphics and audio processor 114.

In this example, main processor 110 (e.g., an enhanced IBM Power PC 750 or other microprocessor) receives inputs from handheld controllers 108 (and/or other input devices) via graphics and audio processor 114. Main processor 110 interactively responds to user inputs, and executes a video game or other program supplied, for example, by external storage media 62 via a mass storage access device 106 such as an optical disk drive. As one example, in the context of video game play, main processor 110 can perform collision detection and animation processing in addition to a variety of interactive and control functions.

In this example, main processor 110 generates 3D graphics and audio commands and sends them to graphics and audio processor 114. The graphics and audio processor 114 processes these commands to generate interesting visual images on display 59 and interesting stereo sound on stereo loudspeakers 61R, 61L or other suitable sound-generating devices.

Example system 50 includes a video encoder 120 that receives image signals from graphics and audio processor 114 and converts the image signals into analog and/or digital video signals suitable for display on a standard display device such as a computer monitor or home color television set 56. System 50 also includes an audio codec (compressor/decompressor) 122 that compresses and decompresses digitized audio signals and may also convert between digital and analog audio signaling formats as needed. Audio codec 122 can receive audio inputs via a buffer 124 and provide them to graphics and audio processor 114 for processing (e.g., mixing with other audio signals the processor generates and/or receives via a streaming audio output of mass storage access device 106). Graphics and audio processor 114 in this example can store audio related information in an audio memory 126 that is available for audio tasks. Graphics and audio processor 114 provides the resulting audio output signals to audio codec 122 for decompression and conversion to analog signals (e.g., via buffer amplifiers 128L, 128R) so they can be reproduced by loudspeakers 61L, 61R.

Graphics and audio processor 114 has the ability to communicate with various additional devices that may be present within system 50. For example, a parallel digital bus 130 may be used to communicate with mass storage access device 106 and/or other components. A serial peripheral bus 132 may communicate with a variety of peripheral or other devices including, for example:

a programmable read-only memory and/or real time clock 134,

a modem 136 or other networking interface (which may in turn connect system 50 to a telecommunications network 138 such as the Internet or other digital network from/to which program instructions and/or data can be downloaded or uploaded), and

flash memory 140.

A further external serial bus 142 may be used to communicate with additional expansion memory 144 (e.g., a memory card) or other devices. Connectors may be used to connect various devices to busses 130, 132, 142.

Example Non-Limiting Software and 3D Modeling For Simulating Speed

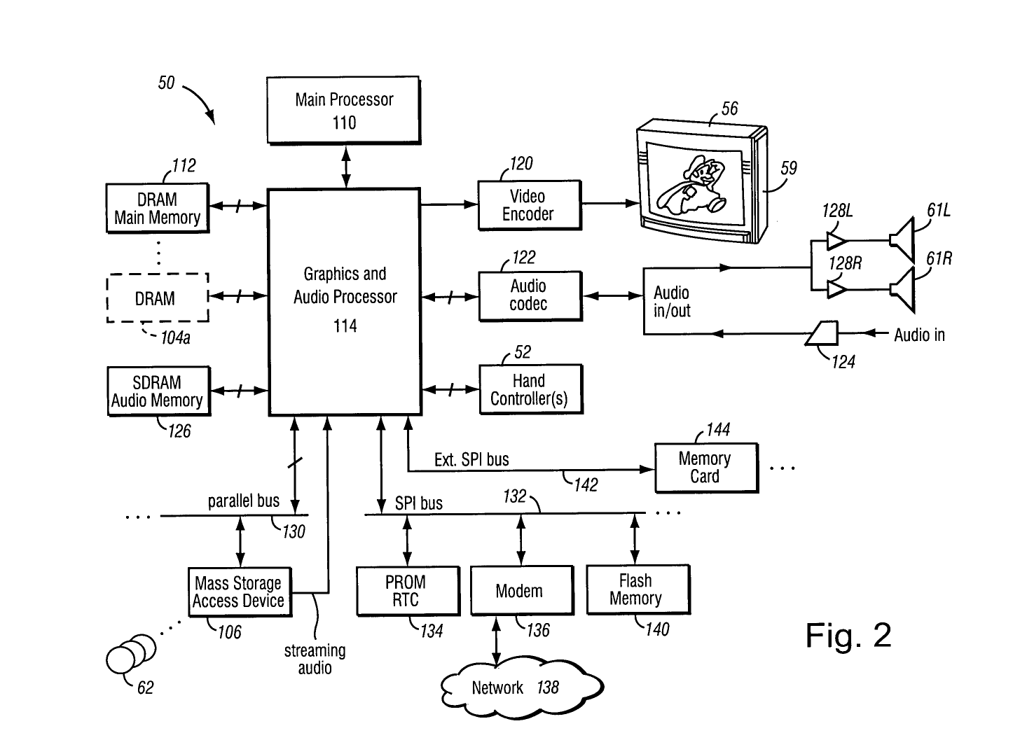

FIG. 3 shows an example of a three-dimensional scene or universe 300 modeled using the FIG. 2 system. In the FIG. 3 example, which is for purposes of illustration only and is in no way limiting, the three-dimensional scene 300 may include various stationary objects such as for example trees 302, a road surface 304, or any other desired realistic or fantastical objects or other features. Additionally, the three-dimensional scene 300 may include one or more moving objects such as for example car 306. The video game platform 50 displays the three-dimensional scene 300 including stationary objects 302, 304 and car 306 from an eye point that is defined by a virtual camera 308. Virtual camera 308 is typically defined as an object within the three-dimensional scene 300, but is usually not visible to the video game player. Virtual camera 308 models camera characteristics such as for example field of view, distance from moving object 306, tilt angle, and other parameters of a real camera. System 50 images three-dimensional scene 300 as if the video game player were viewing the scene through camera 308.

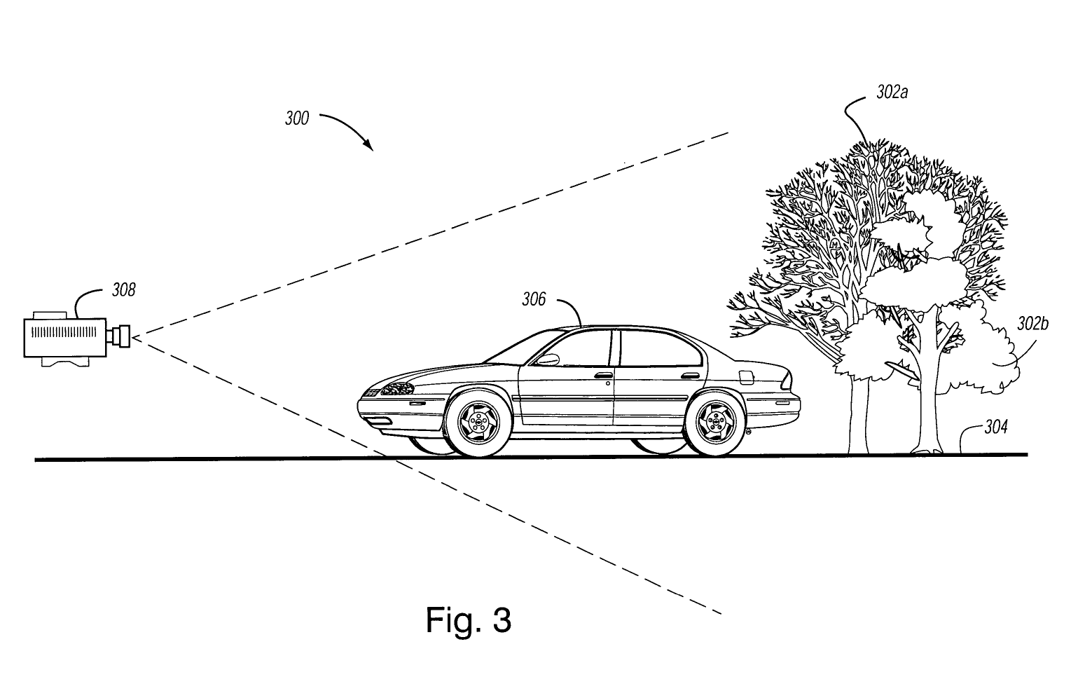

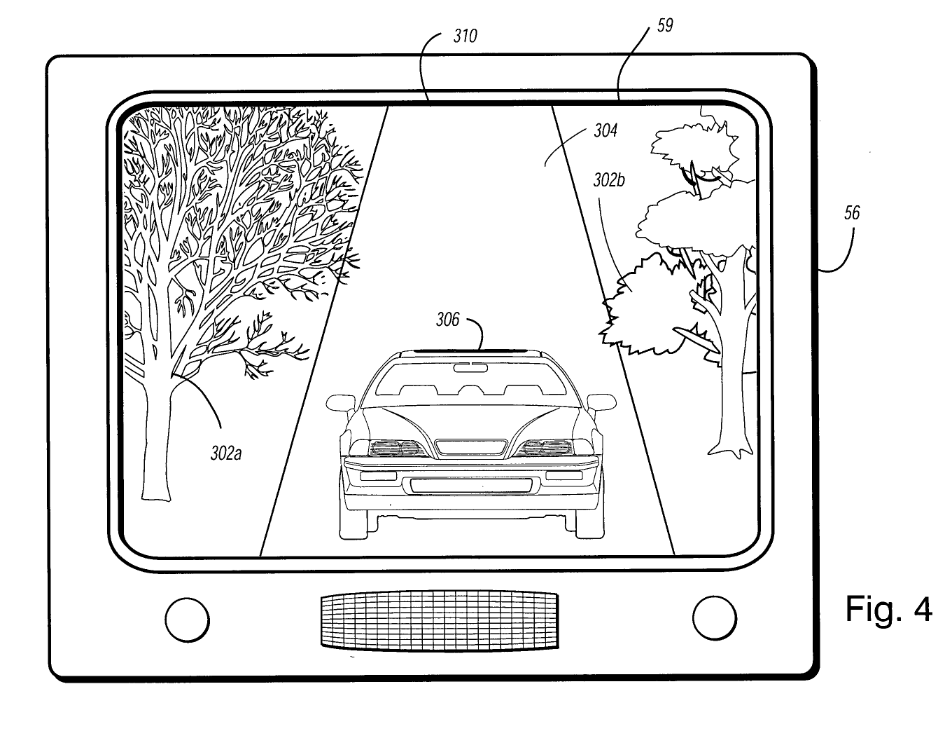

FIG. 4 shows an example image 310 displayed by system 50 on television screen 59. If the field of view of camera 308 is changed (e.g., by the video game player and/or the software), then a somewhat different image as shown in FIG. 5 would be displayed instead. Comparing FIGS. 4 and 5, one can see that the virtual camera 308 has been “zoomed out” somewhat in FIG. 5 and also moved closer to the virtual ground within three-dimensional scene 300 so that the image is more flat.

In an exemplary video game, the video game software changes the amount of “zoom” (i.e., to alter the field of view) of virtual camera 308 and can move the camera anywhere in three-dimensional space and aim it at any desired point within the three-dimensional scene. In exemplary embodiments, the video game software can automatically train camera 308 onto moving object 306 and move the virtual camera with the object so that the virtual camera follows and tracks the moving object. For example, this tracking feature allows the video game player to continually display the moving object 306 (which the video game player may also be controlling using handheld controller) as the moving object moves through the three-dimensional scene. The automatic tracking relieves the video game player from having to manipulate the virtual camera 308 manually, instead allowing the video game player to concentrate on moving and controlling the moving object 306. In other embodiments, the video game player can influence or control camera angle by manipulating controller 52.

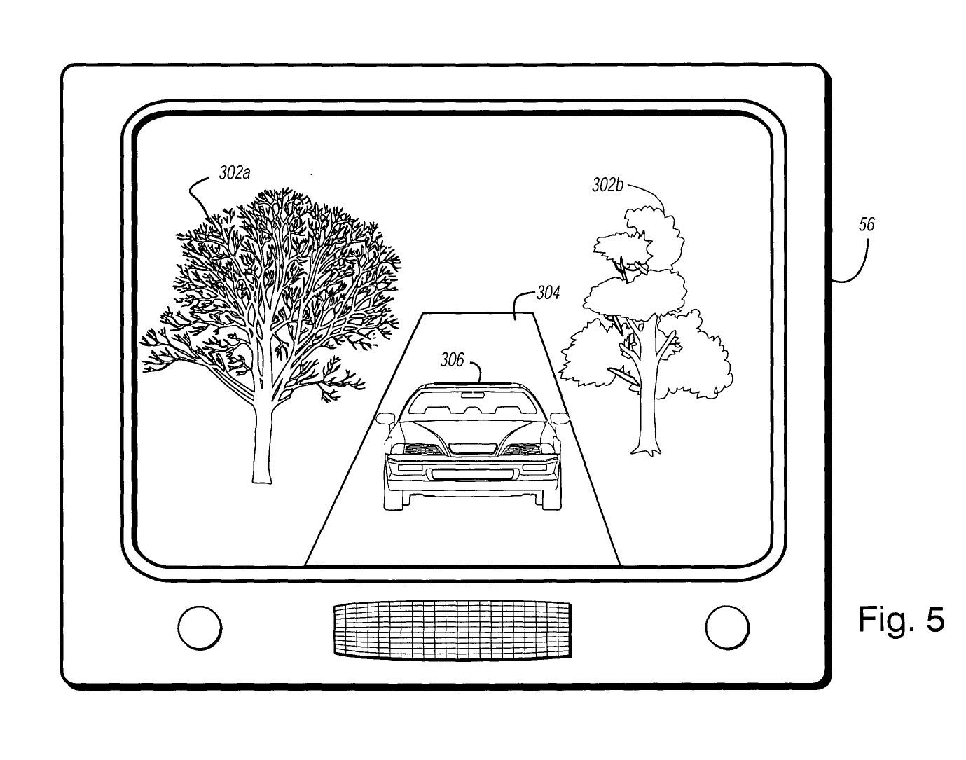

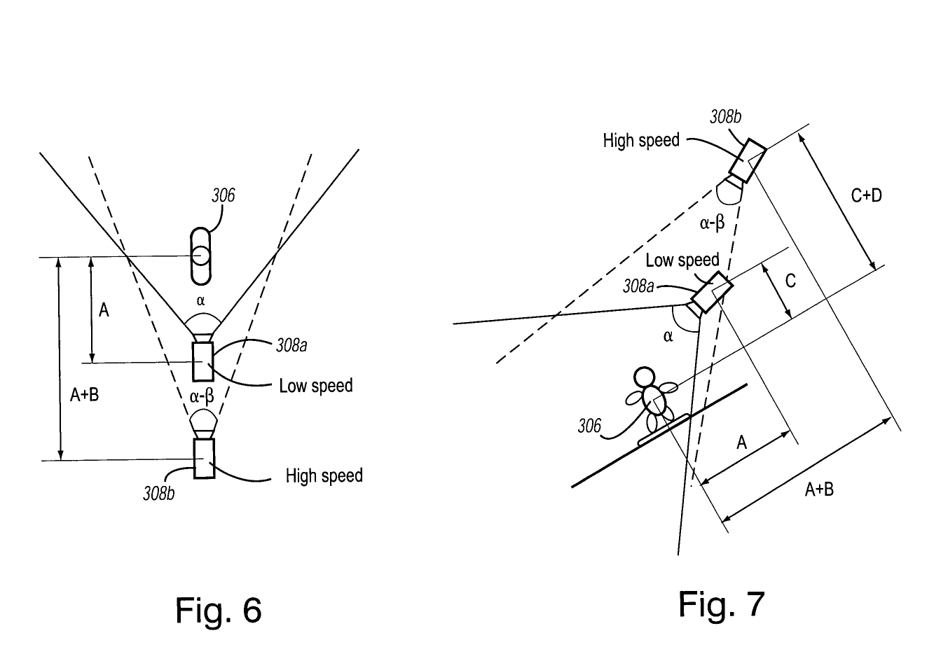

FIGS. 6 and 7 show example changes in the characteristics of virtual camera 308 in response to motion of an exemplary moving object 306. Specifically, in the exemplary non-limiting example shown, virtual camera 308 is defined to have a wider field of view α and to follow a distance A behind moving object 306 when the moving object is moving at a relatively low speed, and is defined to have a narrower field of view α−β and to follow a larger distance A+B behind the moving object when the moving object is moving at a higher speed. Additionally, as shown in FIG. 7, it is possible to automatically increase the distance between the virtual camera 308 from a virtual surface such as the ground and/or from an axis passing through moving object 306 (e.g., from C to C+D) in response to a higher speed of moving object 306. This increase in the apparent height of virtual camera 308 and an increase in the tilt angle of the virtual camera impacts the way the moving object 306 and the rest of the three-dimensional scene 300 are shown on video display screen 59.

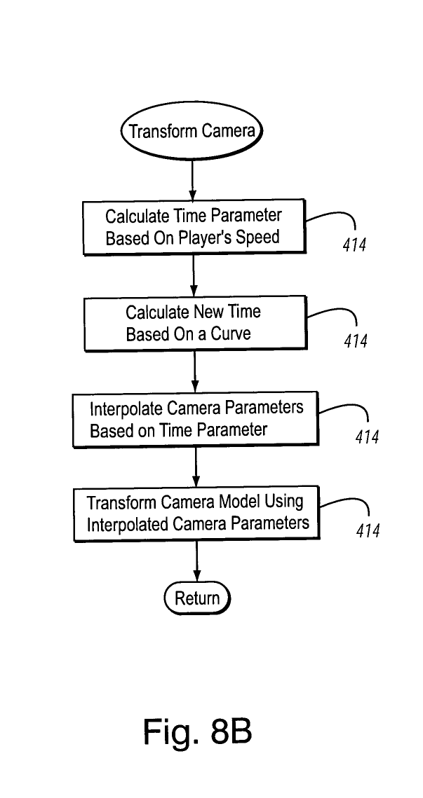

In one exemplary non-limiting embodiment, the field of view is controlled to be indirectly proportional to the rate of motion of the moving object 306. When the moving object 306 begins to move more rapidly, software initially stored on mass media storage device 62 and executed by main processor 110 detects this more rapid motion and decreases the field of view of virtual camera 308. The faster the video game player and/or the software controls moving object 306 to move, the narrower the field of view exhibited by camera 308, and the more “tight” will be the resulting camera shot of the moving object. See FIGS. 9A and 9B, for example. Decreasing the field of view is like “zooming in” on the moving object 306. This effect creates an illusion of increased speed because stationary objects such as trees 302b will more rapidly move in and out of the decreased field of view.

In the exemplary non-limiting illustrative embodiment, at the same time that the field of view of the virtual camera 308 is changed, other camera parameters are also changed in response to the rate of motion of moving object 306. For example, the distance that virtual camera 308 follows moving object 306 is changed, and if desired, the tilt angle and elevation of the virtual camera may also be changed. In the example shown, the camera following distance is changed in a way that is directly proportional to changes in rate of motion of moving object 306. If a moving object 306 goes faster, the distance that virtual camera 308 follows the moving object is also increased. This increased distance in one exemplary illustrative non-limiting embodiment has the effect of compensating for the change in camera field of view with respect to the displayed size of moving object 306. In the example shown, narrowing the field of view has the effect of making moving object 306 appear larger. In the example illustrative embodiment, the distance that virtual camera 308 follows moving object 306 is correspondingly increased to maintain substantially constant object size with narrowed field of view. Similarly, if the moving object 306 begins going more slowly, the field of view of virtual camera 308 is increased and the virtual camera is moved closer to the moving object in order to image more objects and other parts of the scene on the peripheral edges of the image while once again retaining substantially constant moving object displayed size. In some example illustrative embodiments, it may also be desirable to adjust the tilt angle (e.g., provide increased tilt angle as the moving object 306 moves more rapidly) in order to enhance the illusion of increased speed in the image displayed on display 59.

Exemplary Non-Limiting Process

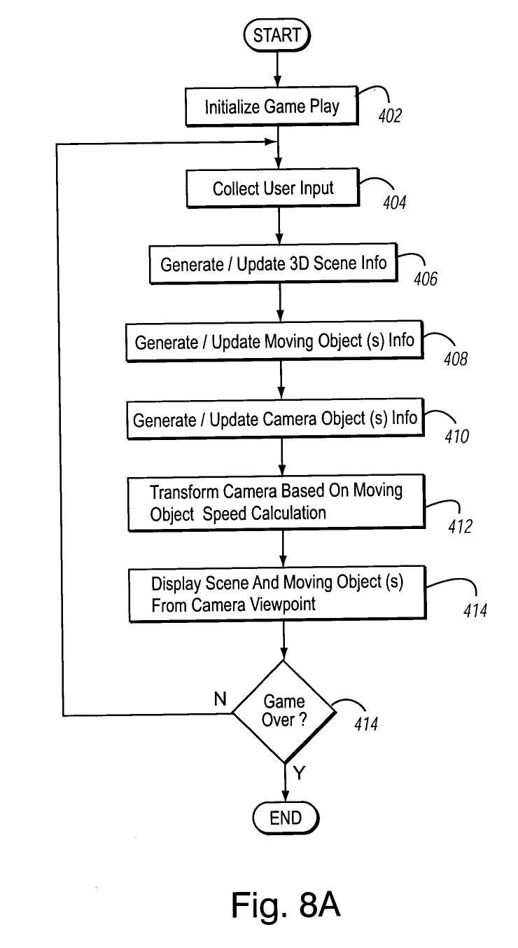

FIG. 8A shows an example flowchart of a non-limiting, exemplary illustrative process performed under program control by processor 110 executing program instructions stored on mass storage device 62. In the particular example shown, program instructions control processor 110 to initialize game play (FIG. 8A, block 402), and to then collect user input from handheld controllers 52 (FIG. 8A, block 404). Based in part on this collected user input, the instructions executed by processor 110 control system 50 to generate and/or update information regarding three-dimensional scene 300 (FIG. 8A, block 406), including, for example, information defining moving object(s) 306 (FIG. 8A, block 408) and information defining/modeling virtual camera 308 (FIG. 8A, block 410). In the example shown, program instructions executed by processor 110 further have the effect of transforming at least some parameters of camera 308 based on a moving object speed calculation (FIG. 8A, block 412). The resulting scene is displayed from the viewpoint of the transformed camera 308 (FIG. 8A, block 414). Assuming the game is not over (“no” exit to decision block 416), steps 404-414 are repeated.

FIG. 8B shows an example more detailed illustrative non-limiting implementation of the FIG. 8A “transform camera” block. In the example shown, the steps used to transform the virtual camera 308 characteristics based on rate of motion of a moving object 306 include:

calculating a time parameter based on the moving object's speed (FIG. 8B, block 420);

calculating a new time based on a curve (FIG. 8B, block 422);

interpolating camera parameters based on the calculated time (FIG. 8B, block 424);

transforming the model of virtual camera 308 using the interpolated camera parameters (FIG. 8B, block 426).

A distinguishing characteristic of real-life driving/racing is the sense of speed obtained by going fast. We present a method to portray this sense of speed while also giving an optimal view of the race ahead. We first perform time calculations, then we interpolate camera parameters and finally we calculate the camera's position, target, and orientation. In more detail, in one exemplary non-limiting embodiment, we introduce a camera system for racing games that tries to give a sense of speed to the end user. At first, we calculate a time based off of the player's speed. Next we take that time and calculate a new time that is based on a curve to allow for the camera's parameters to ease-in and ease-out. Finally, we take the correct time and interpolate the camera's parameters based off starting and ending values for each parameter.

Example Time Calculations (blocks 410, 422)

The interpolation method is first calculated linearly based on the player's speed and then that time is used to get the real time based on a curve to allow for an ease-in and ease-out. In this context, player's speed may be for example the apparent speed that an object is moving through a 3D scene. In a racing game for example, this speed might actively be calculated and displayed (e.g., 77 Km/hour. The speed might depend on play control input from controller 52 and/or virtual environment parameters such as virtual function coefficient of the surface the object is moving on, air friction, wind, etc.

Example Time Equations

Time1=player's speed/(player's max speed*scale value) (EQ. 1)

Time 2=angle1*(1.0f−Time1)+angle2*Time1 (EQ. 2)

Final Time=SIN(Time2)*0.5+0.5 (EQ. 3)

If Final Time>(Previous Time+Max Time Step) then Final Time=Previous Time+Max Time Step

Else if Final Time<(Previous Time−Max Time Step) then Final Time=Previous Time−Max Time Step (EQ. 4)

The scale value in EQ. 1 is used in this example so that the max time (1.0) can be achieved before reaching max speed. The scale value is a variable that can be set. Angle1 and angle 2 in EQ. 2 are degree variables used with the SIN function interpolation to perform the ease-in and ease-out. Both variables can be set.

In EQ. 3, the multiply by 0.5 and add of 0.5 put ending time between 0.0 and 1.0.

When calculating the final time (EQ. 4), the previous time is taken into account in this non-limiting example to provide some hysteresis so that there won't be a big jump from the previous frame in the camera's parameters.

Example Parameter Interpolation

The following are exemplary camera parameters that are interpolated in one non-limiting embodiment. In an exemplary embodiment, the interpolation is done linearly based off of the time calculated and the starting and ending parameter values (higher order or other forms of interpolation could be used if desired). These parameters are in one example:

Field of View—Field of view is used for the perspective calculation matrix.

Distance—The distance back from the camera's target.

Angle Offset—The angle offset for the camera which is added to the ground's angle from the XZ-plane.

Target Offset—3D offset used to move the target off its default position.

Tilt Angle—Camera's up vector is tilted to give the sense that the camera is tilting.

Target Blend—Value used to blend between the previous target direction and the new target direction.

Momentum Distance—Momentum distance is used to scale the distance when switching between different snow or other surfaces.

Here is an example non-limiting linear interpolation equation:

Value=Start Value*(1−time)+End Value*time

The Start Value and the End Value are user defined values in this example.

Exemplary Final Camera Equation

The camera 408 in one example is a camera that is directly connected to the player. In one exemplary embodiment, first the camera's target is calculated by taking the player's position and applying a three-dimensional positional offset. After the camera's target has been found, the camera's position is calculated by moving by X amount of units backwards and Y amount of units up or down. The calculation for the X offset is the cosine of the camera's distance and the Y offset is the sine of the camera's distance. Finally, in one example implementation, the camera's “up” vector is perturbed so that the user gets a feeling that the camera is swaying.

FIGS. 9A, 9B show exemplary screen shots of effects produced by this technique for different speeds. In FIG. 9A, the character is moving at 73 Km/hour and in FIG. 9B the character is moving at 101 Km/hour. Notice the different camera fields of view, angles and distances.

Exemplary Second Camera Split-Screen Effect

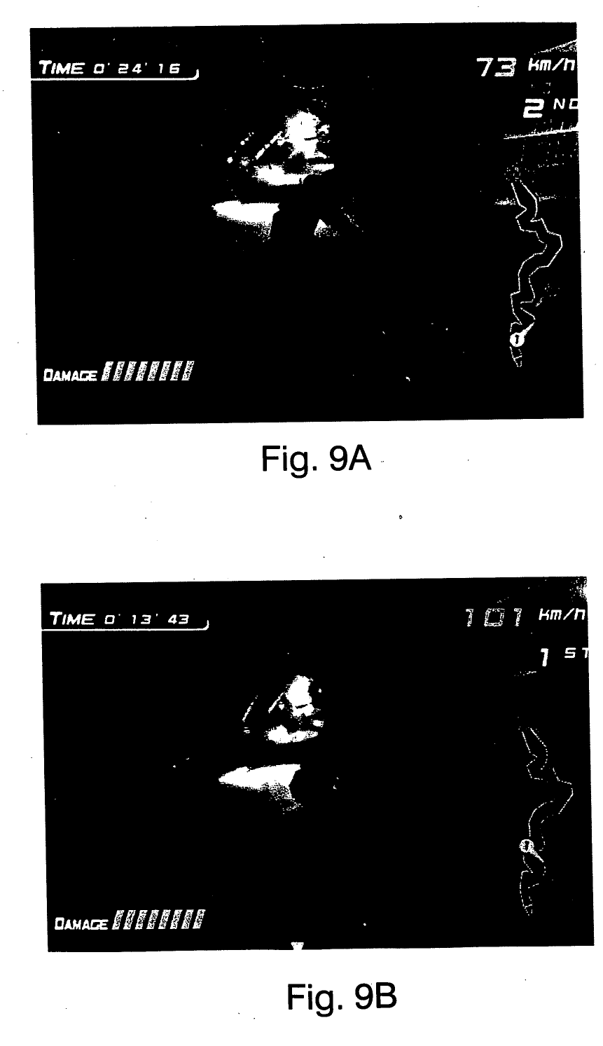

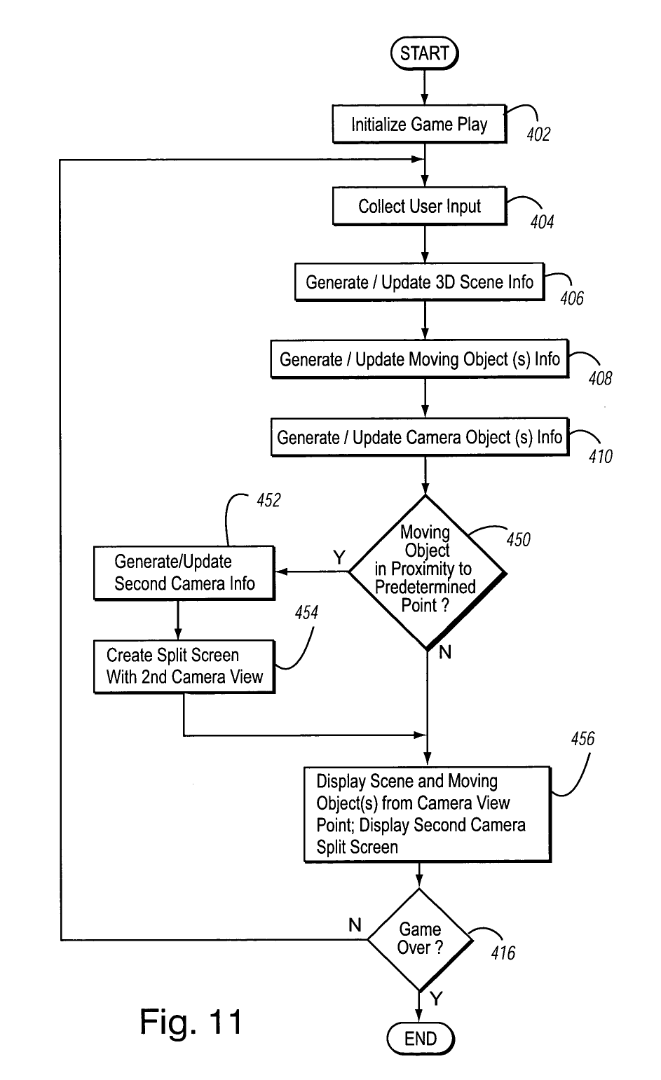

In another exemplary illustrative non-limiting embodiment, program instructions are included on mass storage device 62 that when executed by processor 110 causes the system 50 to dynamically create a second virtual camera with a different viewpoint upon the occurrence of a predetermined condition. In one example non-limiting illustrative embodiment, the predetermined condition is that the moving object 306 moves into proximity with a predetermined or arbitrary point or area. This is shown in FIG. 10. In the example shown, an initial or first virtual camera 308a is trained on moving object 306 and automatically tracks and follows the moving object as the moving object moves through the three-dimensional scene 300. When the moving object 306 moves into proximity with a predetermined point or area within the three-dimensional scene 300, a second virtual camera 308b is activated and/or displayed. The second virtual camera 308b in the example illustrative embodiment has a different viewpoint and/or other characteristics as compared to the viewpoint and/or other characteristics of the first virtual camera 308a. For example, the second camera 308b may be located at a different position (e.g., at a position that is lateral to the moving object 306) to provide a different viewpoint and thus a different perspective of the moving object. In one exemplary illustrative embodiment, the second camera 308b image may be displayed in a split-screen (see FIG. 12) or “picture-in-picture” display so that the video game player can continue to watch the image from the perspective of the first camera 308a while also having the benefit of an interesting, different image from the perspective of the second camera 308b. See FIG. 12.

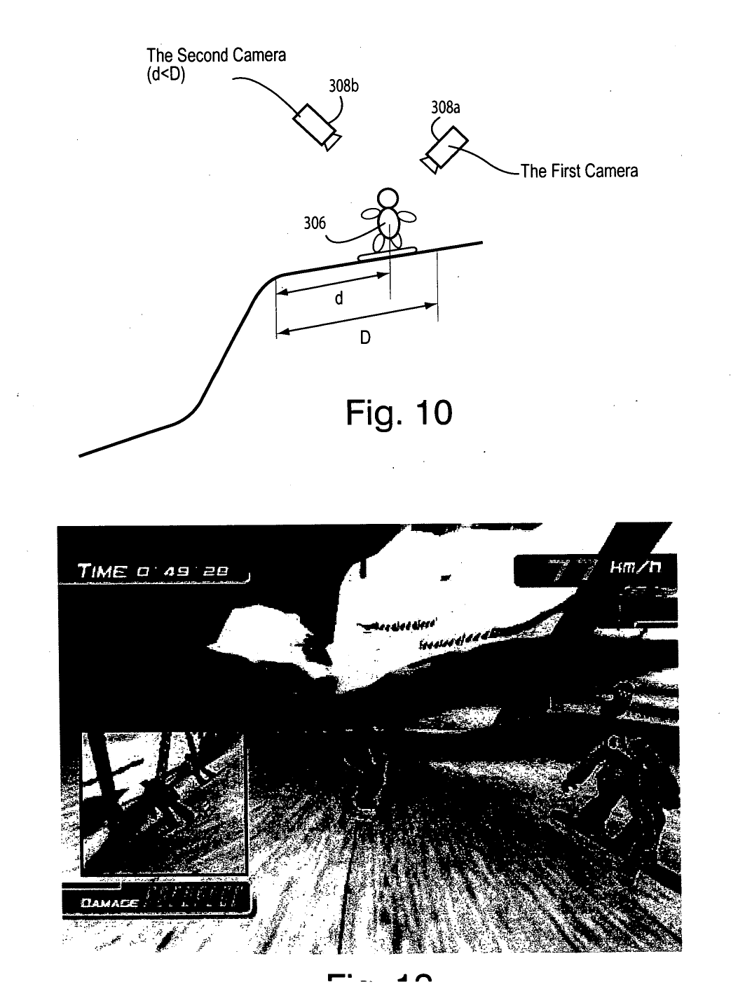

FIG. 11 is a flowchart of exemplary program control steps performed by processor 110 as it reads instructions from mass storage device 62. Blocks 402-410 and 416 are the same as those described previously in connection with FIG. 8A. In this particular illustrative non-limiting embodiment, the program instructions upon being executed by processor 110 determine whether a predetermined event has occurred such as, for example, whether the moving object 306 is in proximity to a predetermined point or is entered into a predetermined area within three-dimensional scene 300 (decision block 450). If the predetermined event has occurred, then the program control instructions are executed to generate/update information defining the second camera 308b (FIG. 11, block 452) and to create a split-screen or picture-in-picture display from the viewpoint of the second virtual camera (FIG. 11, block 454). System 50 then displays the scene with moving objects 306 from the viewpoint of the initial or first virtual camera 308a, as well as displaying any split-screen created by block 454 (FIG. 11, block 456).

While the above disclosure describes determining and/or controlling virtual camera parameters at least in part in response to rate of motion and/or change in rate of motion or other conditions of a moving object and/or proximity of a moving object to a predetermined or arbitrary point or area, other events and conditions could be used instead. For example, it is possible to change camera parameters as described above in response to the moving object moving from one type of surface (e.g., the rough on a simulated golf course, fluffy snow on a simulated ski slope, or sand on a simulated ocean front) to another surface type (e.g., the fairway or green of a simulated golf course, hard packed snow or ice on a simulated ski slope, or water on a simulated ocean front). While particular multiple sets of camera parameters are described above as being changed, less than all of the described parameters can be changed in other implementations depending on the application. Moving objects can be any sort of object including, for example, cartoon characters, racing cars, jet skis, snow boarders, aircraft, balls or other projectiles, or any other sort of moving object, animate or inanimate, real or imaginary. Any number of virtual cameras can be used to create an image display. Parameters relating to the moving objects, the virtual cameras and the backgrounds can all be predetermined based on software instructions, they can be wholly controlled by user manipulation of handheld controllers 52, or a combination. While system 50 has been described as a home video game playing system, other types of computer graphics systems including for example flight simulators, personal computers, handheld computers, cell phones, interactive web servers, or any other type of arrangement could be used instead. Any sort of display may be used including but not limited to raster-scan video displays, liquid crystal displays, web-based displays, projected displays, arcade game displays, or any other sort of display. Mass storage device need not be removable from the graphics system, but could be an embedded storage device that is erasable or non-erasable. Any sort of user input device may be used including for example joysticks, touch pads, touch screens, sound actuated input devices, speech recognition or any other sort of input means.

The invention is not to be limited to the disclosed embodiments. On the contrary, the invention is intended to cover various modifications and equivalent arrangements included within the scope of the claims.

1. A method of generating an interactive three-dimensional display comprising:
displaying a moving object within a three-dimensional scene;
determining the rate said object is moving within the scene; and
simultaneously controlling both the field of view of a virtual camera and the distance of said virtual camera from said object at least in part in response to said determined rate of motion.

2. The method of claim 1 wherein said virtual camera is trained on said moving object.

3. The method of claim 1 wherein said controlling step decreases said field of view as said rate of motion increases.

4. The method of claim 1 wherein said controlling step increases said distance as said rate of motion increases.

5. The method of claim 1 wherein said controlling step decreases said field of view and simultaneously increases said distance as said rate of motion increases.

6. The method of claim 1 wherein said controlling step cooperatively, dynamically controls both said field of view and said distance to maintain substantially constant displayed object size while enhancing the illusion of speed.

7. An image processing apparatus for displaying on a display, from a prescribed viewing point, an image looking at a moving manipulated object that appears in a three-dimensional space, comprising:
player manipulated manipulating means for changing the rate of motion of said manipulated object;
rate of motion calculating means for calculating the rate of motion of said manipulated object according to the manipulation of said manipulating means;
image viewing angle setting means for setting the viewing angle for the image seen from said viewing point, based on the rate of motion calculated by said rate of motion calculating means;
distance setting means for setting the distance between said manipulated object and said viewing point, based on the rate of motion calculated by said rate of motion calculating means; and
image generating means for generating an image that includes the manipulated object seen from said viewing point, based on the viewing angle set by said viewing angle setting means and the distance set by said distance setting means.

8. An image processing apparatus according to claim 7 wherein said viewing angle setting means sets the viewing angle of an image to decrease as said rate of motion increases, and said distance setting means sets the distance to increase as said rate of motion increases.

9. An image processing apparatus according to claim 7 that displays on a display an image such as one wherein a manipulated object is descending a hill, and additionally comprises a height setting means for setting the height of said viewing point, based on the rate of motion calculated by said rate of motion calculating means, said height setting means setting the height to increase as said rate of motion increases.

10. A storage medium that stores computer instructions controlling video game play, said instructions including:
a first set of instructions defining a moving object within a three-dimensional scene;
a second set of instructions defining a virtual camera within said three-dimensional scene, said virtual camera being trained on said moving object; and
a third set of instructions that dynamically change the field of view and position of said virtual camera within the three-dimensional scene based at least in part on the rate of motion of said moving object within said three-dimensional scene.

11. The storage medium of claim 10 wherein said third set of instructions narrows the field of view of said virtual camera as said rate of motion increases.

12. The storage medium of claim 10 wherein said third set of instructions increases the distance between said virtual camera and said moving object as said moving object's rate of motion increases.

13. The storage medium of claim 10 wherein said third set of instructions narrows said virtual camera's field of view and increases the distance between said virtual camera and said moving object in response to said moving object's rate of motion to provide an illusion of speed without substantially changing the displayed size of said moving object.

14. A method of generating a graphical display comprising:
defining an object moving through a three-dimensional scene;
determining when said moving object moves into proximity with a predetermined point within said three-dimensional scene; and
dynamically activating a virtual camera and associated split-screen display in response to said determining step.

15. A method of generating a graphical display comprising:
defining a moving character moving through a three-dimensional scene;
displaying said moving object from the viewpoint of a first virtual camera;
determining when said moving object moves into proximity with a predetermined point within said three-dimensional scene; and
in response to said determining step, selectively activating an additional virtual camera displaying said moving object from a different viewpoint.

16. The method of claim 15 wherein said selectively activating step includes displaying said moving object from said different viewpoint within a split screen while continuing to display said moving object from the viewpoint of said first-mentioned virtual camera.

17. An image processing apparatus for displaying on a display, from a prescribed viewing point, an image looking at a moving manipulated object that appears in a three-dimensional space, comprising:
manipulating means manipulated by a player for controlling the movement of said manipulated object;
first image generating means for generating a first image from the viewing point of a first camera located behind said manipulated object and following the movement of said object as it responds to the manipulation of said manipulating means;
determining means for determining whether or not said manipulated object has come close to an arbitrary point;
second image generating means for generating a second image looking at said manipulated object from a viewing point of a second camera located in a direction different than said first camera, when it has been determined by said determining means that said manipulated object has come close to said point; and
image display control means for displaying said first image on said display and also superimposing said second image on said first image for a split-display.

18. An image processing apparatus according to claim 17 wherein said determining means determines whether or not said manipulated image has passed said point, and wherein said image display control means deletes said second image displayed on said display when said determining means has determined that said manipulated object has passed said point.

19. An image processing apparatus according to claim 17 wherein the viewing point of said second camera can be set to any 360 degree direction.

20. A storage medium storing program instructions that, when executed, generate a visual display, said instructions including:
a first set of instructions that displays an object moving a three-dimensional scene from the viewpoint of a first virtual camera;
a second set of instructions that determines when said moving object moves into proximity with a predetermined position or area within said three-dimensional scene; and
a third set of instructions that, in response to said determination, selectively activates a second virtual camera display having a viewpoint that is different from the viewpoint of said first virtual camera.

21. The storage medium of claim 20 wherein said third set of instructions includes instructions that display said moving object within a split-screen from a viewpoint different from said first virtual camera's viewpoint.

22. The storage medium of claim 20 wherein said third set of instructions includes instructions that deactivates said second virtual camera display when said moving object moves out of proximity from said predetermined position or area.
